(19) United States
(12) Patent Application Publication
(10) Pub. No.: US 2014/0139449 A1
(43) Pub. Date: May 22, 2014

(54) TRANSMISSION INTERFACE FOR A TOUCH SYSTEM

(71) Applicant: PRINCETON TECHNOLOGY CORPORATION, New Taipei City (TW)

(72) Inventors: Chien-Hsien TSAI, New Taipei City (TW); Wei-Lung LEE, New Taipei City (TW); Chieh Yung TU, New Taipei City (TW)

(73) Assignee: PRINCETON TECHNOLOGY CORPORATION, New Taipei City (TW)

(21) Appl. No.: 13/796,040

(22) Filed: Mar. 12, 2013

(30) Foreign Application Priority Data
Nov. 16, 2012 (TW) 101142754

(51) Int. Cl. G06F 3/041

(52) U.S. Cl. CPC G06F 3/041
USPC 345/173

(57) ABSTRACT

A transmission interface for a touch system is provided. The touch system includes a micro controller and a touch device, the transmission interface comprising: a single transmission wire, connected between the micro controller and the touch device, for bi-directional transmission between the micro controller and the touch device.

### CROSS REFERENCE TO RELATED APPLICATIONS

This Non-provisional application claims priority under 35 U.S.C. §119(a) on Patent Application No(s). 101,142,754, filed in Taiwan, Republic of China on Nov. 16, 2012, the entire contents of which are hereby incorporated by reference.

### BACKGROUND OF THE INVENTION

1. Field of the Invention

The present invention relates to bi-directional transmission technology for touch systems.

2. Description of the Related Art

A touch device can be a touch panel, which integrates a display with touch sensors. Since the touch device can bring users a more intuitive operation experience, it is widely used in electronic products.

In the prior art, the communication between the touch device and controller is based on protocols such as I²C and SPI. These protocols require a plurality of transmission lines, and thus lead to more complex structures. For the I²C protocol, it requires only two transmission lines, but each message transmission can only be performed in one direction, thus causing inconvenience.

### SUMMARY OF THE INVENTION

The present invention provides a transmission interface for a touch system, wherein the touch system comprises a micro controller and a touch device, the transmission interface comprising: a single transmission wire, connected between the micro controller and the touch device, for bi-directional transmission between the micro controller and the touch device.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram of a touch system according to an embodiment of the present invention.

FIG. 2 is a schematic diagram of the message format in the single wire transmission protocol of the present invention.

FIG. 3 is a timing diagram of the messages according to the first embodiment of the present invention.

FIG. 4 is a timing diagram of the messages according to the second embodiment of the present invention.

FIG. 5 is a timing diagram of the messages according to the third embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

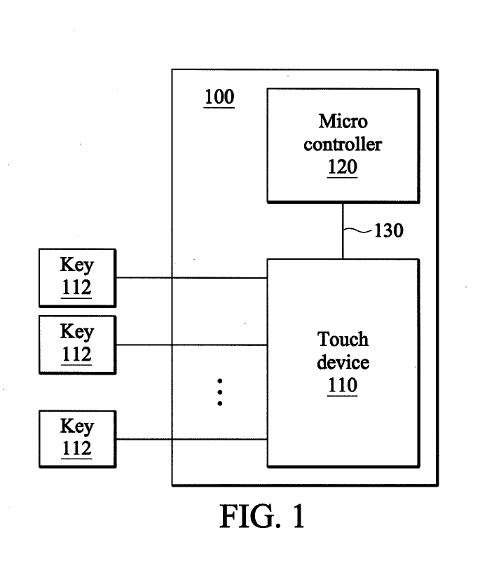

To overcome the deficiencies in the prior art, the present invention provides bi-directional transmission technology for a touch systems. FIG. 1 is a schematic diagram of a touch system according to an embodiment of the present invention. In the touch system 100, the touch device 110 can detect whether its keys 112 have been pressed or released. The touch device 110 and the other peripheral devices (not shown) are controlled by a micro controller (MCU) 120. Note that in the present invention, there is only a single transmission wire between the touch device 110 and the micro controller 120. The single transmission wire 130 is connected between the micro controller 120 and the touch device 110 for bi-directional transmission therebetween.

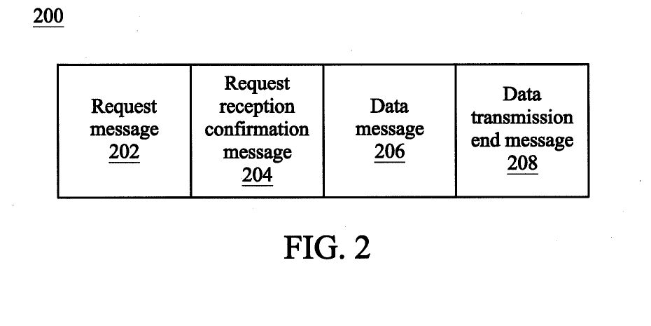

To improve the stability of the single transmission wire when performing the bi-directional transmission, the present invention also provides a single wire transmission protocol. FIG. 2 is a schematic diagram of the message format in the single wire transmission protocol of the present invention. The message format 200 in the single wire transmission protocol comprises the following in order: (1) a request message 202, which indicates a request from one of the micro controller and the touch device to the other; (2) a request reception confirmation message 204, which indicates that the request has been received and confirmed; (3) a data message 206, which includes the data for responding to the request; and (4) a data transmission end message 208, which indicates that the transmission of the data has ended. Three transmission modes between the touch device 110 and the micro controller 120 according to the single wire transmission protocol of the present invention are described in the following embodiments.

First Embodiment

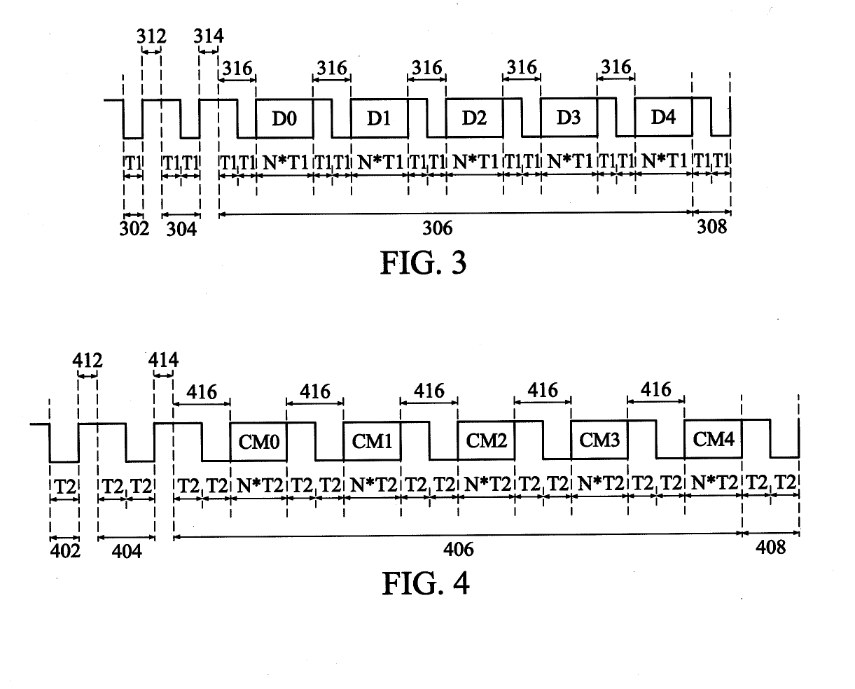

FIG. 3 is a timing diagram of the messages according to the first embodiment of the present invention. The first embodiment describes the scenario where a user presses a key on the touch device. In this embodiment, the request message 302 is sent from the touch device 110. The request reception confirmation message 304 and the data transmission end message 308 are sent from the micro controller 120. The data message 306 indicates the value of the key 112 (i.e., data D0, D1˜D4). In some embodiments, one can add some synchronous messages (312, 314 as shown in FIG. 3) between the request message 302 and the request reception confirmation message 304, and/or between the request reception confirmation message 304 and the data message 306 to prevent the touch device 110 and the micro controller 120 from failing to handshake with each other. In some embodiments, to reduce data transmission errors, one can add headers (316 as shown in FIG. 3) for the data message 306. In some embodiments of the present invention, the length of the request message 302 has a specific ratio to that of the request reception confirmation message 304, so that the touch device 110 and the micro controller 120 can easily recognize those messages. As shown in FIG. 3, the length of the request message 302 is T1 and the length of the request reception confirmation message 304 is twice of T1. Therefore, the specific ratio between them is 1:2. The specific ratio can be used to inspect whether the transmission is correct. Those skilled in the art can understand that the present invention should not be limited to the embodiments described above. In some embodiments, the transmission condition can also be determined by inspecting the data pattern in those messages.

Second Embodiment

FIG. 4 is a timing diagram of the messages according to the second embodiment of the present invention. The second embodiment describes the scenario where the micro controller 120 attempts to set the touch device 110. In this embodiment, the request message 402 is sent from the micro controller 120; and the request reception confirmation message 404 and the data transmission end message 408 are sent from the touch device 110. The data message 406 indicates the parameters (CM0, CM1˜CM4) with which the micro controller 120 sets the touch device 110. In some embodiments, one can add some synchronous messages (412, 414 as shown in FIG. 4) between the request message 402 and the request reception confirmation message 404, and/or between the request reception confirmation message 404 and the data message 406 to prevent the touch device 110 and the micro controller 120 from failing to handshake with each other. In some embodiments, to reduce data transmission errors, one can add headers (416 as shown in FIG. 4) for the data message 406. In some embodiments of the present invention, the length of the request message 402 has a specific ratio to that of the request reception confirmation message 404, so that the touch device 110 and the micro controller 120 can easily recognize those messages. As shown in FIG. 4, the length of the request message 402 is T2 and the length of the request reception confirmation message 404 is twice of T2. Therefore, the specific ratio between them is 1:2. The specific ratio can be used to inspect whether the transmission is correct. Those skilled in the art can understand that the present invention should not be limited to the embodiments described above. In some embodiments, the transmission condition can also be determined by inspecting the data pattern in those messages.

Third Embodiment

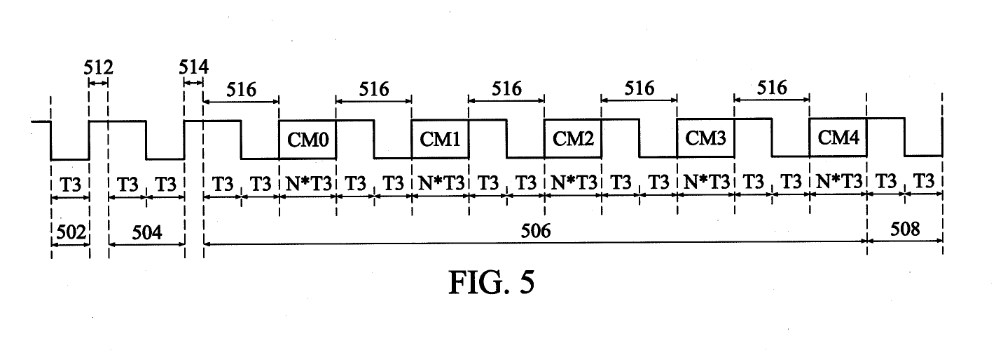

FIG. 5 is a timing diagram of the messages according to the third embodiment of the present invention. The third embodiment describes the scenario where the touch device 110 attempts to reset itself. In this embodiment, the request message 502 and the data transmission end message 508 are sent from the touch device 110, and the request reception confirmation message 505 is sent from the micro controller 120. The data message 506 indicates the parameters (CM0, CM1˜CM4) with which the micro controller 120 resets the touch device 110. In some embodiments, one can add some synchronous messages (512, 514 as shown in FIG. 5) between the request message 502 and the request reception confirmation message 504, and/or between the request reception confirmation message 504 and the data message 506 to prevent the touch device 110 and the micro controller 120 from failing to handshake with each other. In some embodiments, to reduce data transmission errors, one can add headers (516 as shown in FIG. 5) for the data message 506. In some embodiments of the present invention, the length of the request message 502 has a specific ratio to that of the request reception confirmation message 504, so that the touch device 110 and the micro controller 120 can easily recognize those messages. As shown in FIG. 5, the length of the request message 502 is T3 and the length of the request reception confirmation message 504 is twice of T3. Therefore, the specific ratio between them is 1:2. The specific ratio can be used to inspect whether the transmission is correct. Those skilled in the art can understand that the present invention should not be limited to the embodiments described above. In some embodiments, the transmission condition can also be determined by inspecting the data pattern in those messages.

Note that in embodiments mentioned above, the request message can be sent again when the request reception confirmation message or the data transmission end message is not detected. With the single wire transmission protocol of the present invention, the communication structure in the touch system can be much simpler and has better communication quality.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A transmission interface for a touch system, wherein the touch system comprises a micro controller and a touch device, the transmission interface comprising:
a single transmission wire, connected between the micro controller and the touch device, for bi-directional transmission between the micro controller and the touch device.

2. The transmission interface for the touch system as claimed in claim 1, wherein the single transmission wire transmits data between the micro controller and the touch device according to a single wire transmission protocol, and the message format of the single wire transmission protocol comprises the following in order:
a request message, indicating a request from one of the micro controller and the touch device to the other;
a request reception confirmation message, indicating that the request has been received and confirmed;
a data message, including the data for responding to the request; and
a data transmission end message, indicating that the transmission of the data has ended.

3. The transmission interface for the touch system as claimed in claim 1, wherein when a key of the touch device is pressed:
the request message is sent from the touch device; and
the request reception confirmation message and the data transmission end message is sent from the micro controller,
wherein the data message indicates the value of the key.

4. The transmission interface for the touch system as claimed in claim 1, wherein when the micro controller attempts to set the touch device:
the request message is sent from the micro controller; and
the request reception confirmation message and the data transmission end message are sent from the touch device,
wherein the data message indicates the parameters with which the micro controller sets the touch device.

5. The transmission interface for the touch system as claimed in claim 1, wherein when the touch device attempts to reset itself:
the request message and data transmission end message are sent from the touch device; and
the request reception confirmation message is sent from the micro controller,
wherein the data message indicates the parameters with which the micro controller resets the touch device.

6. The transmission interface for the touch system as claimed in claim 1, wherein there is a synchronous message between the request message and the request reception confirmation message, and/or between the request reception confirmation message and the data message.

7. The transmission interface for the touch system as claimed in claim 1, wherein the data message further comprises a plurality of headers.

8. The transmission interface for the touch system as claimed in claim 1, wherein the length of the request reception confirmation message has a specific ratio to the length of the request message.
